(19) United States
(12) Patent Application Publication
(10) Pub. No.: US 2008/0205572 A1
(43) Pub. Date: Aug. 28, 2008

(54) Apparatus and process for generating nuclear heat

(76) Inventor: Talbot A. Chubb, Arlington, VA (US)

Correspondence Address: MELVIN L. CRANE, 318 SOUTH CLEVELAND STREET, ARLINGTON, VA, 22204-2038, US

(21) Appl. No.: 11/893,172

(22) Filed: Aug. 16, 2007

Related U.S. Application Data
(63) Continuation-in-part of application No. 10/696,516, filed on Oct. 30, 2003, now abandoned.

(51) Int. Cl. G21B 3/00

(52) U.S. Cl. 376/100; 976/DIG. 1

(57) ABSTRACT

A deuterium-fueled heat source that utilizes solid state electrolysis device(s) that deposit D atoms onto, and remove D atoms from, a metal reactor plate containing deuterium diffusion-impeding inclusions.

This Application is a CONTINUATION-IN-PART of application Ser. No. 10/696,516 filed Oct. 30, 2003.

### FIELD OF THE INVENTION

This invention relates to heat generating processes and more particularly to heat generating processes in which deuterium participates in exothermic nuclear reactions in condensed matter. Further, the invention is directed to low energy nuclear reactions taking place in condensed matter, which includes radiationless cold nuclear fusion and other nuclear transmutations. It adds to the art developed by Iwamura et al. between 1996 and 2002, which art avoids instabilities in reactors using excessively non-equilibrium D/Pd content as taught by Fleischmann and Pons (1989)

### SUMMARY OF THE INVENTION

The invention describes an apparatus and process which causes deuterium to participate in exothermic nuclear reactions in a condensed matter environment. The process uses solid state electrolysis device(s) that deposit D atoms onto, and/or remove D atoms from, a metal reactor plate containing deuterium diffusion-impeding ionic solid crystallites. The process recirculates deuterium that has not participated in a nuclear reaction during an earlier passage through the metal reactor plate.

The process uses an assembly containing a metal reactor plate interfaced with either one or two solid-electrolyte layers. The assembly is mounted inside a containment enclosure pierced with hermetically sealed electrical feed-through fittings, and which is filled with deuterium gas D₂. The containment enclosure contains a metal reactor plate capable of absorbing deuterium, and which supports diffusion flow of deuterium in response to an internal deuterium density gradient. The reactor plate is fabricated so as to contain a dispersion of ionic solid crystallites that impede, but do not prevent deuterium diffusion flow within the plate. In a favored implementation of the process, the two exterior faces of the reactor plate are each coated with a solid state electrolyte. Each solid electrolyte layer is overcoated with a metal foil which is capable of dissolving deuterium. Metal foil, solid electrolyte, and contacting surface of the reactor plate form an electrolysis cell. There is an inflow electrolysis cell through which deuterium flows before entering the reactor plate, and an outflow electrolysis cell through which deuterium flows after leaving the reactor plate. The rims of the reactor plate, the two electrolyte layers, and the two metal foils are coated with an electrical insulator, which constitutes an annular rim insulator. The annular rim insulator is penetrated at the metal plate's rim with an electrical conducting wire, which passes through one of the feed-through fittings so as to permit connection to an external source of voltage and current outside the containment enclosure. Separate electrical wires make contact with the two metal foils, and pass through the wall of the containment enclosure through separate metal feed-through fittings. All wire passages through the walls of the containment enclosure are vacuum-tight sealed. A hermetic gas input tube penetrates the containment enclosure wall. The input tube is used to introduce deuterium gas into the cell during a preparation period during which a desired initial quantity of deuterium dissolves into the various metal components and a desired initial quantity of deuterium gas fills the containment enclosure. The gas input tube can be sealed off before the process operation.

During the process operation, deuterium gas is absorbed into the positive electrode of the front electrolysis cell. The absorbed deuterium in ion form passes through the front electrolysis cell and enters the front layer of the reactor plate, flows through the reactor plate where it is subject to scatterings at many ionic solid metal interfaces, mostly passes out the back surface of the reactor plate into the back electrolysis cell with its covering metal foil, and re-enters the gas volume of the containment enclosure as deuterium gas. This deuterium circulation is driven by serial voltage potentials applied across the inflow and outflow electrolysis cells. The scattering process converts some of the diffusing deuterium into a nuclearly active configuration. The nuclearly active configuration deuterium participates in exothermic nuclear reactions. Released nuclear energy converts into heat within the reactor plate. Subsequent heat transfer delivers the generated heat to a user application.

An alternate implementation of the process uses a single solid-electrolyte layer, which is interfaced with an outflow surface of the metal reactor plate and an outflow metal foil, forming thereby an outflow electrolysis cell. In this one-electrolysis-cell implementation of the process, inflowing deuterium gas adsorbs directly onto the inflow face of the reactor plate and absorbs into the interior of the reactor plate. The outflow electrolysis cell returns deuterium gas to the containment enclosure.

Another implementation of the process uses a single solid-electrolyte layer, which is interfaced with an inflow metal foil and with the inflow surface of the metal reactor plate, forming thereby an inflow electrolysis cell. In this input-electrolysis-cell implementation of the process, outflowing deuterium gas desorbs directly out of the outflow face of the reactor plate into the deuterium gas present within the containment enclosure.

Three alternate implementations of the process are identical to those described above, except that they replace the use of a dispersion of diffusion-impeding ionic solid crystallites by the use of one or more diffusion-impeding non-metallic deuterium-scattering layers.

### OBJECTS OF THE INVENTION

Iwamura et al. (1996) described an apparatus for testing permeation plate reactors for excess heat and nuclear emissions. The permeation property of the plate reactors was enabled by deuterium ion-in-metal diffusion. The apparatus used a heavy water-based (D₂O) electrolysis cell to deposit deuterium on the top surface of a horizontal permeation plate reactor. They removed outflow deuterium gas from the bottom surface of the reactor plate by a vacuum pump. They presented evidence for Watt-level excess heat in one run. Iwamura et al. (1998) reported studies which used essentially the same apparatus to test permeation plate reactors containing layered CaO crystallites, and reported 5 runs which produce Watt-level excess heat. The post-run reactor plates were reported to have new surface atoms that they believed might be transmutation products. They subsequently focused their studies on the surface transmutation process. Iwamura et al. (2002) describe apparatus that applied pressurized D₂ gas to the inflow surface of a permeation plate reactor and used a vacuum pump to remove deuterium that had exited from the bottom of the reactor plate. They reported that when the apparatus used a deuterium permeation flow through a permeation plate reactor containing layered CaO inclusions, and when the inflow surface was also coated with a sub-monolayer of Cs, the Cs was quantitatively transmuted to Pr.

One object of the invention is to provide a D₂-fusion reactor that improves on the reactor apparatus described in Iwamura et al. (1998) by reducing the parasitic electric power that drives the permeation flow, thereby increasing excess heat power. Iwamura et al. (1998) used a liquid heavy-water-based electrolysis cell to deposit deuterium on the inflow surface of a permeation plate reactor. The Applicant's invention uses an input gas reservoir in combination with a solid electrolyte cell to convert D₂ gas into surface deuterium on the inflow surface of the same permeation plate reactor. The invention apparatus adds a second solid electrolyte cell to replace a vacuum pump used by Iwamura et al. (1998) to remove outflow deuterium that had exited the outflow surface of their reactor plate. In the invention outflow D₂ gas from the reactor plate assembly enters the input gas reservoir, completing a closed loop deuterium flow system.

Another object of the invention is elimination of a risk of explosion that is present in the Iwamura et al. (1998) process. In the Iwamura et al. (1998) process heavy water is dissociated to produce O₂ gas and hydrogen. Part of the hydrogen is in the form of D₂ gas. The apparatus includes a recombination catalyst to safely recombine any hydrogen gas mixed with the O₂ gas so as to prevent accumulation of an explosive mix. The invention process avoids use of a liquid electrolyte and avoids accumulation of a reactive neutral product like D₂ gas on the cell's anode. In the invention process, the anode product is deuterium ions, which drift through the electrolyte as part of the closed-cycle deuterium flow system. No recombination catalyst is needed.

Another object of the invention is a reduced probability of contaminant atoms being deposited on the input surface of the permeation reactor plate. A solid electrolyte is less likely to contain contaminants than a liquid electrolyte bath, and the invention's lower polarizing voltage makes a contained contaminant less likely to be deposited on the cathode surface than occurs with the higher voltage used by Iwamura et al. (1998).

Another object of the invention is to increase the combination of a high deuterium chemical potential maintained on the front surface of the reactor plate together with a high permeation rate beyond that achieved in the Iwamura et al. (1998) process. This increase is made possible by the invention's use of an outflow electrolysis cell in addition to an inflow electrolysis cell.

Another object is to increase the heat output over that achieved in Iwamura et al. (1998) by providing the process operator with means for adjusting both the input deuterium chemical potential and the permeation flow rate by using independent adjustments on the potentials applied to the separate inflow and outflow solid electrolyte cells.

The Iwamura et al. (2002) achieved effective contaminant control over the input surface of its permeation plate reactor. An object of the invention is to maintain comparable contamination control while increasing the D₂ fusion heat generation rate by increasing the combined deuterium chemical potential maintained on the front surface of the permeation reactor plate and the permeation flow rate.

Another object of the invention is to provide apparatus and process that consistently demonstrate generation and release of radiationless D₂ fusion heat.

Another object of the invention is to provide apparatus and process that has improved utility as a test bed to enable reliable comparison of the heat generation capabilities of test permeation plate reactors that differ in design detail, such as in their internal distribution of ionic solid-metal interfaces, and the compositions, shapes and areas of the interfaces.

### BRIEF DESCRIPTION OF THE DRAWINGS

FIGS. 1, 2, and 5 are schematic cross sectional drawings illustrating two different assemblies that implement the invention;

FIG. 1 is an edge view of an assembly that supports left-to-right deuterium permeation through a multi-crystallite scattering-layers reactor plate;

FIG. 2 is a front end view of the assembly shown in FIG. 1;

FIG. 3 is an approximate one-million-times-magnified scaled cross sectional view of a portion of FIG. 1 showing detail not shown in FIG. 1;

FIG. 4 is a picture of the ionic solid crystallite structure believed present in the CaO layers shown in FIG. 3 and designated as item 11; and

FIG. 5 is an alternative assembly that supports upward deuterium flow through a reactor plate.

### DETAILED DESCRIPTION

The cold fusion process is a catalytic process in which surface and interface sciences are used to reduce the temperature at which exothermic reactions can take place. Catalysis substitutes configuration change for kinetic impact in promoting reaction. The configuration change employed is a coherent partitioning of the deuterium ion within an interface layer between a metal lattice and an ionic crystal. This change delocalizes deuteron charge density. Delocalization is the opposite of a process that increases charge density, such as in muon-catalyzed fusion. Coherent partitioning creates a geometry that forbids emission of energetic neutrons, protons, and gamma rays. In addition, coherent partitioning adds lattice degrees of freedom to the product nucleus. The lattice geometry of the nucleus allows energy transfer to the hosting solid lattice via phonons. The process avoids strong inside-metal electric fields and deuteron acceleration. In the process a portion of a forced deuterium flow through a metal reactor makes contact with a salt-metal interface volume inside the reactor metal and undergoes a catalyzed configuration change and subsequent radiationless fusion reaction.

The apparatus supporting the process uses inside-metal structures taught by Iwamura et al. Iwamura et al. constructed metal plate nuclear reactors containing internal CaO—Pd metal interfaces. They have demonstrated transmutation of surface Cs atoms into surface Pr atoms in each of more than 50 experiments They use clean deuterium flow methods rather than electrolysis. Their Cs transmutations are equivalent to the absorption of 4 deuterons by each surface Cs atom. The transmutations do not to occur when normal hydrogen is substituted for deuterium, nor when the internal interfaces between CaO crystal and Pd metal are not included within the reactor. Since great cleanliness is maintained, since the transmutation product covers a major fraction of the cesium-coated surface of their reactor, and since sequential measurements show that the increase in surface Pr matches the decrease in surface Cs, an explanation in terms of contamination is unphysical. The transmutations have been repeated by Higashiyama et al. at Osaka University.

The invention apparatus supporting the nuclear process uses solid electrolyte electrolysis cells in contact with an Iwamura-type reactor plate to maintain and control a continuous closed loop circulation of deuterium through the reactor plate at a higher flow rate and higher D/Pd ratio than exists during the Iwamura et al. 2002 experiments.

The invention process generates heat by exothermic nuclear reactions in which deuterium participates, and uses solid state electrolysis device(s) that deposit D atoms onto, and/or remove D atoms from a metal reactor plate containing deuterium diffusion-impeding barriers. Deuterium that fails to participate in a nuclear reaction during passage through the metal reactor plate is re-circulated so as to maintain time-independent compositions, except for a slow build-up of helium gas. The process can be carried out using a number of alternate hardware assemblies. The Figures illustrate two such assemblies.

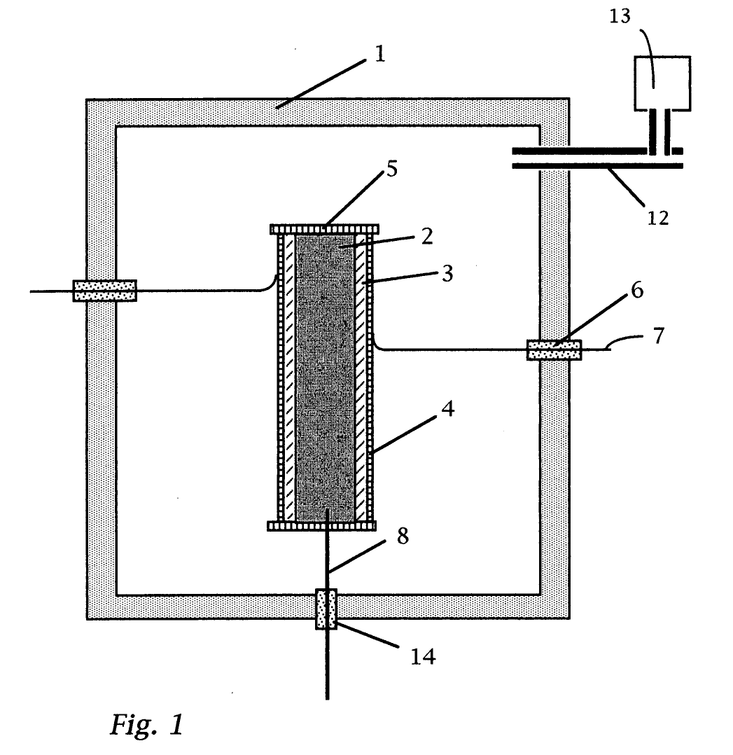

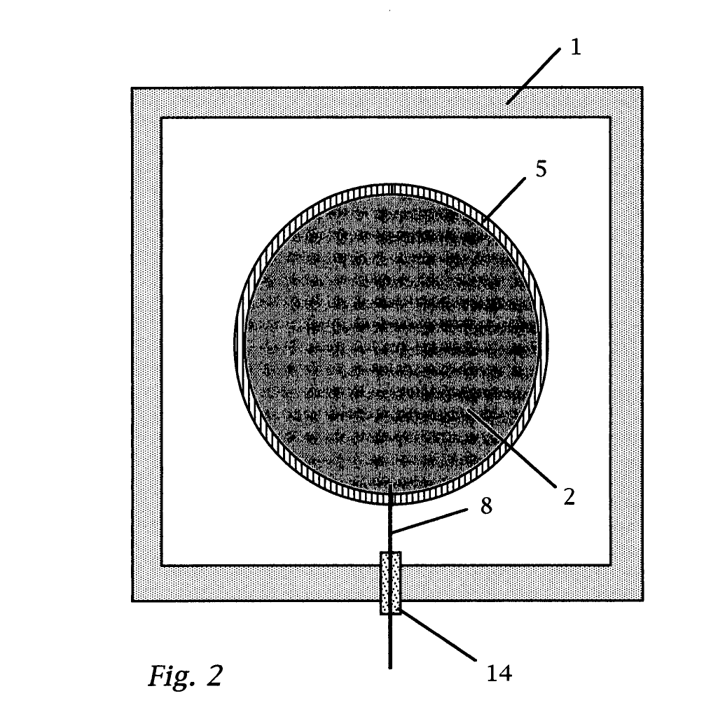

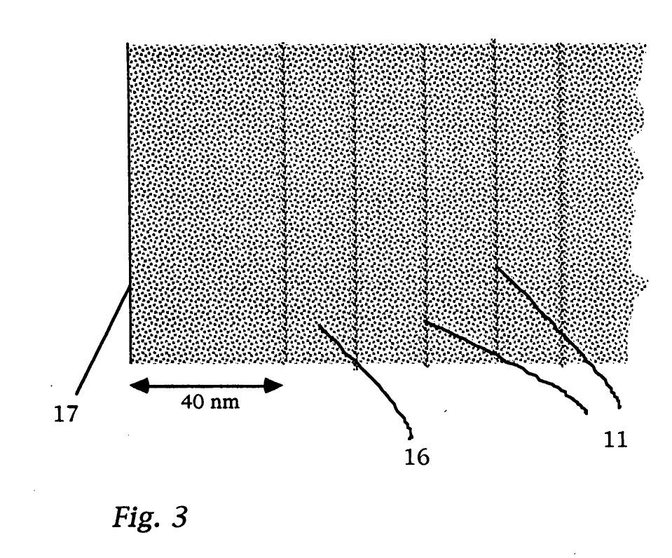

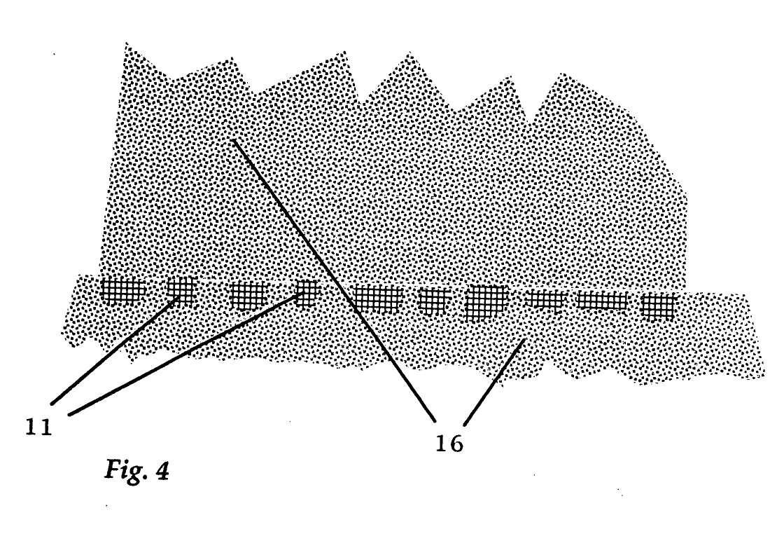

Now referring to FIGS. 1 and 2, pressure tight containment enclosure 1 is formed by aluminum, steel or other impervious metal, and contains an interior assembly comprising a flat permeable but non-porous metal reactor plate 2 interfacing on its left and right side planar surfaces with left and right layers of solid electrolyte 3. The reference characters in FIGS. 1 and 2 identify the right side components, but apply equally to the left side components. Both left and right layers of solid electrolyte 3 make surface contact with left and right permeable but non-porous metal foils 4. Reactor plate 2 is made of Pd. Now referring to FIG. 3, within reactor plate 2 there is a left-side grouping of five layers 11 of CaO embedded in Pd metal 16. The CaO layers are not shown in FIG. 1. The CaO layer closest to the left surface of reactor plate 2 is located about 40 nm inward and parallel to the left planar surface 17 of the plate. The layers of CaO are 2 nm thick. Within the grouping, the CaO—CaO layer separation is about 18 nm. The thickness, separation, and distance of the CaO layers from the closest metal surface of reactor plate 2 are as taught by Y. Iwamura, M. Sakano, and T. Itoh, Jpn. J. Appl. Phys. 41A, pp. 4642-4650, (2002), by Y. Iwamura, T. Itoh, M. Sakano, and S. Kuribayashi, in ICCF10 Abstracts, Presentation Tu15, (2003), and by T. Higashiyama, M. Sukano, H. Miyamaru, and A. Takahashi, ICCF10 Proceedings preprint, distributed through www.LENR-CANR.org, pp. 1-6, (2003). Iwamura et al. fabricated their test reactor plates, which have the desired internal layer construction, by starting with a plate of commercially pure Pd metal, coating the reactor plate with a sequence of five 2-nm layers of sputtered CaO, separated by four 18-nm layers of sputtered Pd metal, and topped with a 40-nm layer of sputtered Pd metal. Each individual CaO layer is believed to be in the form of nearly contiguous CaO nano-crystals, as shown in FIG. 4. The layers were deposited using argon ion beam sputtering. Left and right solid electrolyte layers 3 are deposited layers of poly ethylene oxide (PEO), containing deuterided phosphoric acid, as taught by Biberian and G. Lonchampt, Proc. ICCF9 (2002), in “Condensed Matter Nuclear Science”, ed. by Xing Z. Li (Tsinghua University Press, China, 2003) pp. 17-22. Each layer is about 1 mm thick and is a deuteron conductor. The hydrided version of the specified electrolyte has been used in the prior art in lithium batteries, where it operates between 70° C. and 120° C. Left and right electrolyte layers 3 are each covered with a contacting piece of permeable but non-porous metal foil 4. Left and right metal foils 4 are made of Pd or Pd-alloy, and are about 0.1 mm thick. The rim surfaces of reactor plate 2, left and right electrolyte layers 3, and left and right metal foils 4 are held in place by annular rim insulator 5, which may be of poly tetrafluoroethylene plastic (PTFE). The left and right hermetically sealed feed-through insulators 6, which may be made of a ceramic, are sealed to left and right electrical wire leads 7. Left wire lead 7 makes contact with left metal foil 4, and right wire lead 7 makes contact with right metal foil 4. Left and right wire leads are made of Ni. The bottom wire lead 8 passes through feed-through insulator 14 and makes contact with reactor plate 2 by piercing the annular rim insulator 5, as shown in FIGS. 1 and 2. Bottom wire lead 8 is made of Ni. It supports the sub-assembly consisting of reactor plate 2, left and right electrolyte layers 3, left and right metal foils 4, and annular rim insulator 5. Gas supply tube 12 pierces a wall of containment enclosure 1, and is used to fill containment vessel 1 with deuterium gas prior to use, and to furnish pre-operation conditioning deuterium gas which is absorbed by the metal components during conditioning of the system prior to process operation. Square box 13 schematically represents a pressure transducer that produces an electrical output voltage which measures gas pressure inside pressure tight vessel enclosure 1. An example of an operating device uses an enclosure volume of about 10 cubic inches and an operating pressure of about 20 psia.

Prior to process operation, containment vessel 1 is filled with deuterium gas and is heated to above about 70° C. During process operation, wire lead 8 may be connected to ground electrical potential, which is defined as reference potential V=0 volts. Left metal foil 4, left solid electrolyte layer 3, and left surface of metal plate 2 form a left electrolysis cell. The left electrolysis cell is the inflow electrolysis cell. Right metal foil 4, right solid electrolyte layer 3, and right surface of metal plate 2 form a right electrolysis cell. The right electrolysis cell is the outflow electrolysis cell. Left wire lead 7 is connected to an external power supply providing an electrical potential V_{L}, which is positive relative to the left cell zero-current cell potential V_{oL}, thereby polarizing the left cell so as to drive a deuterium permeation flow toward the right. Right wire lead 7 is connected to an external power supply providing an electrical potential V_{R}, which is negative relative to the right cell zero-current cell potential V_{oR}, thereby polarizing the right cell so as to drive a deuterium permeation flow also toward the right. As taught by Biberian and Lonchampt, current flow through left electrolyte removes deuterium dissolved in left metal foil 4 and deposits deuterium onto metal plate 2, which absorbs the deposited deuterium. As taught by Biberian and Lonchampt, left-to-right current flow through right electrolyte 3 desorbs deuterium from metal plate 2 and deposits deuterium onto right metal foil 4, which absorbs the deuterium. Concurrently deuterium gas adsorbs and dissociates on the left surface of left metal foil 4 and desorbs from the right surface of right metal foil 4 into the gas. After metal conditioning and during operation the composition of both left and right electrolytic layers 3 stays constant since inflow deuterium balances outflow deuterium.

During process operation, absorption of deuterium on the left surface of reactor plate 2 and concurrent desorption of deuterium from the right side of reactor plate 2 drives a left-to-right permeation flow of deuterium through reactor plate 2. This permeation flow resembles that used in the studies by Iwamura et al. (2002 and 2003) and Higashiyama et al. (2003), which studies have demonstrated deuterium participation in exothermic nuclear reactions.

The use of a left electrolyte cell in combination with a right electrolytic cell enables a cell operator to alter both permeation rate and average D/Pd ratio in reactor plate 2, so as to optimized fusion rates. When left metal foil is made more positive than reactor plate 2, permeation rate/cm² is increased and average D/Pd ratio is increased. When reactor plate 2 is made more positive than right metal foil 4, permeation rate/cm² is increased while average D/Pd ratio is decreased. When reactor plate 2 is made more negative that right metal foil 4, permeation rate/cm² is decreased, and average D/Pd ratio is increased. Calculations show that potential differences of 0.1 volt are sufficient to drive useful permeation using negligible power.

Although theory and conjecture are not part of the description of the apparatus and process, the description is aided by summarizing the science that seems to explain the Iwamura et al. and Higashiyama et al. results. In T. A. Chubb “The dd Cold Fusion-Transmutation Connection” a quantum mechanics wave equation-wave function model explains how the prescribed permeation flow leads to exothermic nuclear reactions. Quantum mechanics coordinate exchange replaces quantum mechanics tunneling in the reaction model.

Modeling of the process assumes that impeded deuterium permeation flow creates a nuclearly active configuration of wavelike deuterium, which behaves much like the conduction electron medium in a metal. Quantum mechanics uses the term “Bloch function” to describe the nuclearly-active condensed-matter deuterium configuration. The conduction electrons in a metal have a similar delocalized wavelike form and provide a low resistance conduction current flow in response to a voltage potential difference across a metal crystal. Similarly, wavelike deuterium provides a low resistance deuterium conduction permeation flow in response to a difference in the chemical potential of wavelike deuterium across a metal crystal.

The total deuterium permeation flow is modeled as being partitioned between a relatively large diffusion flow of non-nuclearly-active interstitial deuterium within the metal and a relatively small independent conduction flow carried by nuclearly-active wavelike deuterium. The normal form of deuterium in a metal is the non-nuclearly-active interstitial configuration. The normal diffusion flow is driven by a concentration gradient of deuterium in self-trapping potential wells. The normally occupied potential wells in Pd metal are known to be centered on the octahedral sites of the face-centered cubic (fcc) metal lattice. The conduction flow is modeled as being carried by wavelike deuterons occupying shallower, non-self-trapping potential wells, as described in T. A. Chubb “LENR: Superfluids, Self-Trapping and Non-Self-Trapping Sites”. In the Iwamura work the non-self-trapping wells are believed to be located in the interface between ionic solid and adjacent metal, as explained in T. A. Chubb “Inhibited diffusion driven surface transmutations”. At each of the CaO diffusion-impeding layers there is a scattering of both types of deuterium. The scatterings are modeled as reversible scatterings of individual deuterons between self-trapping and non-self-trapping sites. Reversibility requires that a fraction of the normally diffusing deuterons scatter into wavelike deuterons when they cross a diffusion-impeding layer. The resulting wavelike deuterons in the non-self-trapping sites are the nuclearly reactive component which, in Iwamura et al. (2002) spreads out in all directions and participates in exothermic nuclear reactions on the metal surface, releasing heat. The summed nuclear reactions demonstrated by Iwamura et al. and Higashiyama et al. are ¹³³Cs+8D→¹⁴¹Pr+50.5 MeV and ⁸⁸Sr+8D→⁹⁶Mo+˜53.5 MeV.

Prior to the Iwamura et al. (2002) transmutation studies, Iwamura et al. (1998) used a deuterium oxide (D₂O) liquid electrolysis cell as input to a permeation reactor, and produced more nuclear heat than in their later work. Applying understanding gained from the Iwamura et al. (2002) teaching, the Applicant developed an improved version of the Iwamura et al. (1998) apparatus. The invention apparatus and process avoids D₂O electrolyte, removes a source of reactor plate surface contamination, supports closed loop operation, and substantially reduces electric input power.

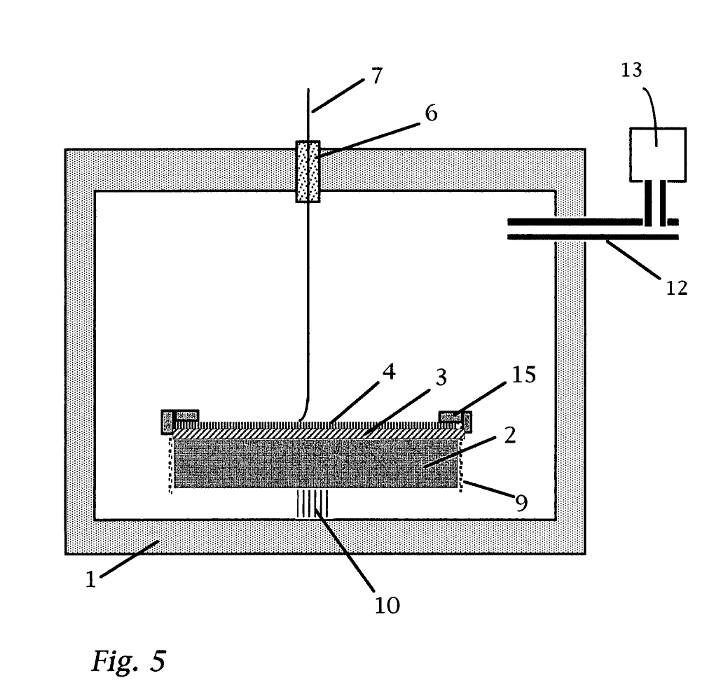

A second implementation of the process uses adsorption of gas directly onto the inflow surface of reactor plate 2 as the first step of a deuterium recirculation loop which includes passage of deuterium through reactor plate 2. Now referring to FIG. 4, pressure tight containment enclosure 1 contains an interior assembly designed to provide an upward deuterium permeation flow through reactor plate 2. In FIG. 4, reactor plate 2 is coated on its annular rim surface by insulator coating 9. Annular insulator coating 9 is made of a non-porous material such as PTFE. Reactor plate 2 is made of Pd metal and contains internally a grouping of diffusion-impeding CaO layers near its bottom planar surface, the internal layers are configured as described in FIG. 3. Reactor plate 2 is supported from the bottom surface of containment enclosure 1 by metal cylinder 10, which is of lesser diameter than reactor plate 2. As a result, a portion of the bottom surface of reactor plate 2 is exposed to deuterium gas within containment enclosure 1 during process operation. Reactor plate 2 makes contact with, and is covered by, solid electrolyte layer 3. Solid electrolyte layer 3 is made of poly ethylene oxide containing deuterided phosphoric acid. Solid electrolyte layer 3 makes contact with and is covered by metal foil 4, which is made of Pd metal. Metal foil 4 is positioned by annular positioning fixture 15, which is made of PTFE. The top surface of reactor plate 2, solid electrolyte layer 3, and metal layer 4 constitute an outflow electrolysis cell. Containment enclosure 1 is made of metal and is connected to electrical ground potential, designated V=0 volts. Wire lead 7, which is made of Ni, passes through feed-through insulator 6 to make contact with metal foil 4. During process operation, wire lead 7 is connected externally to an electrical power supply that keeps metal foil 4 at a potential V which is more negative than the zero-current cell potential Vₒ. During process operation as implemented using the assembly configuration of FIG. 5, deuterium gas within containment vessel enclosure 1 dissociates on the exposed portion of the bottom surface of reactor plate 2. It is known from the prior art that deuterium gas dissociates into atom form when adsorbed onto clean Pd-like metals. The resulting surface atoms are absorbed into the metal of reactor plate 2. At the top surface of reactor plate 2, surface deuterium desorbs from reactor plate 2 and enters solid electrolyte 3 as deuterium ions. With the potential of metal foil maintained at V<Vₒ, a D⁺ ion current flows through solid electrolyte 3 and deuterium is absorbed into the bottom surface of metal foil 4. Deuterium desorbs from the top surface of metal foil 4 as deuterium gas, completing the deuterium recirculation loop. The resulting upward permeation flow through reactor metal 2 creates nuclearly active deuterium as previously described.

Again referring to FIG. 5, a third implementation of the process uses the assembly of FIG. 4 but imposes a reverse electrical polarization of solid-electrolyte layer 3. The reverse polarization reverses the direction of deuterium circulation. The potential of metal foil 4 is maintained at V>Vₒ. deuterium gas within containment vessel enclosure 1 dissociates on the top surface of reactor plate 4, and desorbs downward into solid-electrolyte layer 3. Solid-electrolyte layer 3 functions as the electrolyte of an inflow electrolysis cell. Deuterium plating out of the electrolysis cell deposits onto the top surface of reactor plate 2 and dissolves into the bulk metal. The downward flowing deuterium is subject to scattering. Most of the inflowing deuterium desorbs from the bottom surface of reactor plate 2 as deuterium gas, completing the recirculation process. Optionally, the grouping of CaO layers may be near the top, middle, or bottom of reactor plate 2. In this third implementation of the process, the process takes place at a higher deuterium chemical potential and with a smaller deuterium gradient within the reactor plate than in the second implementation of the process, using the same assembly hardware.

Three additional implementations of the process are identical to the three implementations described above, except that they use a different internal diffusion-impeding structure within reactor plate 2. Instead of using thin non-metallic diffusion-impeding layers, the processes use an internal dispersion of ionic solid crystallites providing contacting ionic solid-metal interfaces within reactor plate 2 as means for scattering nuclearly non-reactive diffusing deuterium into the nuclearly reactive configuration. FIGS. 3 and 4 explain the rationale for using a dispersion of salt-like inclusions in the reactor plate. The high crystallinity of the CaO used by Iwamura et al. suggests that the deposition process leads to distinct crystallites 11 embedded in Pd metal 16, instead of a continuous layer, as shown in FIG. 3 and as described in T. Chubb “Inhibited diffusion driven surface transmutations”. The left surface 17 of the Pd plate shown in FIG. 3 is the inflow surface of the reactor plate as used by Iwamura et al. (2002). Since the interface between CaO crystallite and Pd metal is the deuteron nuclear fusion site in the Iwamura et al. (1996, 1998 and 2002) reactors, use of a more general distribution of ionic solid crystallites resembling the crystalline fragments 11 of the diffusion-impeding CaO layers is within the scope of the invention.

In other options the process replaces uni-directional deuterium permeation flows within reactor plate 2 with back-and-forth deuterium permeation flow, by using a power supply or supplies that repeatedly alternate the potentials applied to wire leads(s) 7 between values more positive and less positive than the zero-current cell potentials.

Many modifications and variations of the assembly hardware supporting process operation are possible in light of the above teachings. Among these is that of inserting additional permeation plate reactors into the closed loop deuterium flow path, and that of inserting heat exchanger assemblies adjacent to the permeation plate reactors to deliver fusion heat to a user. Also, among these is the application of an AC potential across individual solid electrolyte layers to provide initial heat to raised the temperature of the attached permeation plate to a desired operating temperature. Also, among these is that of replacing the planar sequence of component layers with a cylindrical sequence of the same functional elements. Also, it is well known in the art of fuel cell technology and in the physics of metal-hydrogen systems that one can coat a metal's surface with fine Pd powder or Pd—Ag alloy powder, thereby increasing the effective surface area for absorption of hydrogen into the metal's bulk. Also, it is well known in prior art that use of Pd coatings on a metal's de-oxidized surface can permit absorption of hydrogen into a metal's bulk for metals which form oxides that otherwise block absorption of hydrogen. Use of such surface treatments on the metal foil(s) and/or on the reactor plate, and use of metals other than Pd or Pd alloys for the foil(s) and/or reactor plate within the assembly should be considered as within the scope of the invention. Furthermore, use of internal non-metallic layers made of materials other than CaO within a reactor plate have been taught by Iwamura et al. The number, placement, uniformity, and thickness of the internal non-metallic layers can be widely varied provided that deuterium permeation is not prevented, and provided that the impeding of the deuterium permeation flow is sufficient to scatter amounts of deuterium into the nuclearly reactive state that are comparable to, or greater than the amounts achieved by Iwamura et al. (2002). For example, inclusion of both a left and right grouping of diffusion-impeding layers could be used with back and forth deuterium permeation flow through reactor plate 2 of FIG. 1. Addition of voltage control circuitry using signals from pressure transducer 13 together with temperature readings as a basis for setting the electrolysis cell voltages should be considered as within the scope of the invention. The invention can also be used in conjunction with various laser and acoustic stimulation devices, such as are being used as enhancers in cold fusion test devices. It is therefore to be understood that within the scope of the appended claims the invention may be practiced otherwise than as specifically described.

What is claimed:

1. Apparatus and process for generating heat by exothermic nuclear reactions in which reactions deuterium participates, and in which deuterium flows out of an electrically polarized solid-electrolyte layer into a metal reactor plate, and in which deuterium flows out of the metal plate into a second polarized solid-electrolyte layer, with the reactor plate containing one or more layers of diffusion-impeding non-metallic inclusions.

2. The apparatus and process of claim 1 in which at least one diffusion-impeding layer is made of CaO.

3. The apparatus and process of claim 1 in which the non-metallic inclusions are made of salt-like crystallites of metal halide or metal oxide.

4. The apparatus and process of claim 1 in which the metal reactor plate is made of metal selected from a group comprising Pd or Pd alloy.

5. The apparatus and process of claim 1 in which the solid-electrolyte layers are made of poly ethylene oxide (PEO), containing deuterided phosphoric acid.

6. The apparatus and process of claim 1 in which process flow direction alternates in response to changes in potentials applied across the solid electrolyte layers.

7. Apparatus and process for generating heat by exothermic nuclear reactions in which reactions deuterium participates, and in which deuterium gas flows from a deuterium gas reservoir into and through an input electrolysis cell containing a solid electrolyte layer interfaced with a metal reactor plate, from which reactor plate deuterium flows out of the outflow surface of the reactor plate into the deuterium gas reservoir, thereby completing a gas circulation loop, with the reactor plate containing at least one layer of diffusion-impeding non-metallic inclusions.

8. Apparatus and process for generating heat by exothermic nuclear reactions in which reactions deuterium participates, and in which deuterium gas is adsorbed onto the inflow surface of a metal reactor plate, from which reactor plate deuterium flows out of the outflow surface of the reactor plate into an electrically polarized solid-electrolyte layer, with the reactor plate containing at least one layer of diffusion-impeding non-metallic inclusions.

9. Apparatus and process for generating heat by exothermic nuclear reactions in which reactions deuterium participates, with the apparatus including a reservoir enclosure filled with anhydrous, carbon-free D₂ gas and containing a metal reactor plate, with the gas-filled reservoir enclosure and the reactor plate being segments of a closed-loop circulation path in which deuterium flows out of the gas reservoir onto and through a non-porous inflow metal foil, through an electrically polarized solid-electrolyte layer, onto the non-porous inflow surface of the metal reactor plate, passes through the reactor plate by permeation flow driven by a drop in deuterium chemical potential between the inflow and outflow surfaces of the reactor plate, into a second polarized solid-electrolyte layer, and out through a non-porous outflow metal foil into the gas reservoir enclosure, with the gas reservoir enclosure containing a filling tube by which the process operator can admit D₂ gas into the reservoir, and containing separate electrical leads by which the operator can apply independent voltage potentials across the inflow and outflow solid-electrolyte layers, with the reactor plate containing a dispersion of diffusion-impeding ionic solid crystallite inclusions within its interior volume, with the inflow and outflow foils and the reactor plate containing hydrogen-permeable metal, and with the edges of the 2 electrochemical cells and the permeation plate reactor being coated with a non-porous insulating material.

10. The apparatus and process of claim 9 in which the ionic solid crystallite inclusions are made of CaO.

11. The apparatus and process of claim 9 in which the ionic solid crystallite inclusions are made of salt-like crystallites of metal halide or metal oxide.

12. The apparatus and process of claim 9 in which the non-metallic inclusions consist of metal oxides selected from a group comprising magnesium oxide, cesium oxide, strontium oxide, lithium oxide, beryllium oxide, boron oxide, zirconium oxide, nickel oxide, iron oxide, vanadium oxide, and titanium oxide.

13. The apparatus and process of claim 9 in which the metal reactor plate is made of metal selected from a group comprising Pd and Pd alloy.

14. The apparatus and process of claim 9 in which the solid-electrolyte layers are made of poly ethylene oxide (PEO), containing deuterided phosphoric acid.

15. The apparatus and process of claim 9 in which the solid-electrolyte layer is made of a non-metal selected from a group comprising alkali metal deuteroxides, alkali metal oxides, and alkali metal hydroxides, or a mixture thereof.

16. The apparatus and process of claim 9 in which the process flow direction alternates in response to changes in potentials applied across the solid-electrolyte layers.

17. Apparatus and process for generating heat by exothermic nuclear reactions in which reactions deuterium participates, and in which deuterium gas flows from a deuterium gas reservoir into and through an input electrolysis cell containing a solid electrolyte layer interfaced with a metal reactor plate, from which reactor plate deuterium flows out of the outflow surface of the reactor plate into the deuterium gas reservoir, thereby completing a gas circulation loop, with the reactor plate containing a dispersion of diffusion-impeding non-metallic inclusions.

18. The apparatus and process of claim 17 in which the non-metallic inclusions are made of CaO.

19. The apparatus and process of claim 17 in which the metal reactor plate is made of metal selected from a group comprising Pd or Pd alloy.

20. Apparatus and process for generating heat by exothermic nuclear reactions in which reactions deuterium participates, and in which deuterium gas is adsorbed onto the inflow surface of a metal reactor plate, from the reactor plate deuterium flows out of the outflow surface of the reactor plate into an electrically polarized solid-electrolyte layer, with the reactor plate containing a dispersion of diffusion-impeding non-metallic inclusions.
